(19) United States
(12) Patent Application Publication
(10) Pub. No.: US 2024/0183358 A1
(43) Pub. Date: Jun. 6, 2024

(54) AIR BLOWING DEVICE AND AIR CONDITIONING SYSTEM INCLUDING SAME

(71) Applicant: DAIKIN INDUSTRIES, LTD., Osaka (JP)

(72) Inventors: Tomohiro ISHIBASHI, Osaka (JP); Zuozhou CHEN, Osaka (JP); Kaname MARUYAMA, Osaka (JP); Anan TAKADA, Osaka (JP)

(73) Assignee: DAIKIN INDUSTRIES, LTD., Osaka (JP)

(21) Appl. No.: 18/404,445

(22) Filed: Jan. 4, 2024

Related U.S. Application Data
(63) Continuation of application No. PCT/JP2022/023822, filed on Jun. 14, 2022.

(30) Foreign Application Priority Data
Jul. 5, 2021 (JP) 2021-111302

(51) Int. Cl. F04D 19/00; F04D 25/08; F04D 29/38; F04D 29/54

(52) U.S. Cl. CPC F04D 19/007; F04D 25/08; F04D 29/38; F04D 29/542

(57) ABSTRACT

A fixed blade has a chord line inclined downstream in a rotation direction of a rotor vane throughout a radial direction. An average of an installation angle on an outer peripheral side of the fixed blade from a midpoint of a straight line extending in the radial direction from an outer peripheral end of an upstream edge of the fixed blade to an outer peripheral surface of the fixed hub is less than an average of the installation angle on an inner peripheral side of the fixed blade from the midpoint of the straight line, where the installation angle is formed by the chord line of the fixed blade with respect to a plane perpendicular to an axis.

### TECHNICAL FIELD

The present disclosure relates to an air blowing device that includes a stator vane including a plurality of fixed blades, and a rotor vane including a plurality of rotary blades and disposed upstream of the stator vane; and an air conditioning system including the air blowing device.

### BACKGROUND ART

Patent Document 1 discloses an air blowing device including a stator vane and a rotor vane. The stator vane includes a fixed hub and a plurality of fixed blades protruding radially outward from the fixed hub and circumferentially spaced apart from one another. The rotor vane includes a plurality of rotary blades and is disposed upstream of the stator vane. In this air blowing device, the main flow of air discharged from the rotor vane is more concentrated on outer peripheral portions of the rotary blades than on radially central portions of the rotary blades. Thus, the attaching angle of the fixed blade on an outer peripheral side from the radially central portion of the fixed blade is set greater than the attaching angle of the fixed blade on an inner peripheral side from the radially central portion, where the attaching angle is formed by the fixed blade relative to a plane perpendicular to the center axis of the stator vane. Accordingly, the impact loss on the outer peripheral side from the radially central portion of the fixed blade is decreased. Furthermore, tip vortices are generated at the outer periphery of the rotary blade. Thus, the attaching angle of the fixed blade at its outer peripheral end is set smaller than the attaching angle of the fixed blade at its radially central portion. Accordingly, the impact loss at the outer peripheral end of the fixed blade is reduced.

### CITATION LIST

### Patent Document

Patent Document 1: WO 2015/083371

### SUMMARY

A first aspect of the present disclosure is directed to an air blowing device including: a stator vane (18) including a fixed hub (19) and a plurality of fixed blades (20) that protrude radially outward from the fixed hub (19) and are circumferentially spaced apart from one another; and a rotor vane (30) including a plurality of rotary blades (32) and disposed upstream of the stator vane (18). The fixed blade (20) has a chord line (CHL) inclined downstream in a rotation direction of the rotor vane (30) throughout a radial direction. An average of an installation angle (θ) on an outer peripheral side of the fixed blade (20) from a midpoint of a straight line extending in the radial direction from an outer peripheral end of an upstream edge of the fixed blade (20) to an outer peripheral surface of the fixed hub (19) is less than an average of the installation angle (θ) on an inner peripheral side of the fixed blade (20) from the midpoint of the straight line, where the installation angle (θ) is formed by the chord line (CHL) of the fixed blade (20) with respect to a plane perpendicular to an axis (AX). The rotary blade (32) has a chord line (CHL) inclined upstream in the rotation direction throughout the radial direction.

### BRIEF DESCRIPTION OF THE DRAWINGS

FIG. 1 is a block diagram showing a configuration of an air conditioning system.

FIG. 2 is a perspective view of a chiller unit.

FIG. 3 is a perspective view of an air blowing device according to a first embodiment.

FIG. 4 is a plan view of the air blowing device.

FIG. 5 is a cross-sectional view of the air blowing device taken along a meridian plane.

FIG. 6 is a perspective view of a fixed hub and its surrounding area without an upper surface portion of the fixed hub.

FIG. 7 is a cross-sectional view taken along line VII-VII in FIG. 4.

FIG. 8 is a graph showing the relation between the installation angle and the ratio of a radial distance from the fixed hub to the radial length of the upstream edge of each fixed blade.

FIG. 9 is a graph showing the relation between the ratio of a radial distance from the fixed hub to the radial length of the upstream edge of each fixed blade and the angle formed by a centerline and the axis of the fixed blade at the downstream end of the fixed blade, where the centerline extends through the center of the fixed blade in the thickness direction.

FIG. 10 is a perspective view of a rotor vane.

FIG. 11A shows a velocity distribution of air around a fixed blade.

FIG. 11B corresponds to FIG. 11A, where the installation angle of a fixed blade at an outer peripheral portion thereof is set smaller than in FIG. 11A.

FIG. 12 corresponds to FIG. 3 and illustrates a comparative example.

FIG. 13 is a graph showing the relation between the installation angle and the ratio of the radial distance from the fixed hub to the radial length of the upstream edge of each fixed blade according to the first embodiment and the comparative example.

FIG. 14 is a graph showing the relation between the swirling velocity and the ratio of the radial distance from the fixed hub to the radial length of the upstream edge of each fixed blade according to the first embodiment and the comparative example.

FIG. 15 is a graph showing the relation between the average swirling velocity and the difference obtained by subtracting the installation angle of each fixed blade at the outer peripheral end of the upstream edge of the fixed blade from the installation angle of the fixed blade at the inner peripheral end of the upstream edge of the fixed blade.

FIG. 16 is a graph showing the relation between the static pressure efficiency of the air blowing device and the difference obtained by subtracting the installation angle of the fixed blade at the outer peripheral end of the upstream edge of the fixed blade from the installation angle of the fixed blade at the inner peripheral end of the upstream edge of the fixed blade.

FIG. 17 corresponds to FIG. 3 and illustrates a second embodiment.

FIG. 18 corresponds to FIG. 10 and illustrates another embodiment.

### DESCRIPTION OF EMBODIMENTS

Embodiments of the present disclosure will be described below with reference to the drawings.

### First Embodiment

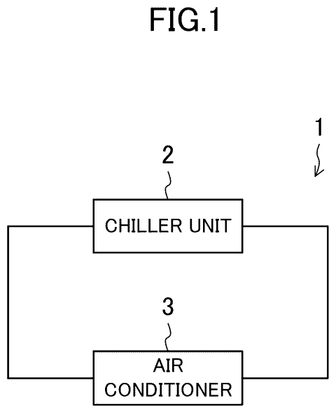

FIG. 1 shows an air conditioning system (1). The air conditioning system (1) includes a chiller unit (2) configured to adjust a temperature of a heating medium, and an air conditioner (3) configured to regulate a temperature of air using the heating medium having the temperature adjusted by the chiller unit (2) and supply the temperature-regulated air into a room. The air conditioner (3) includes, for example, an air handling unit and a fan coil unit.

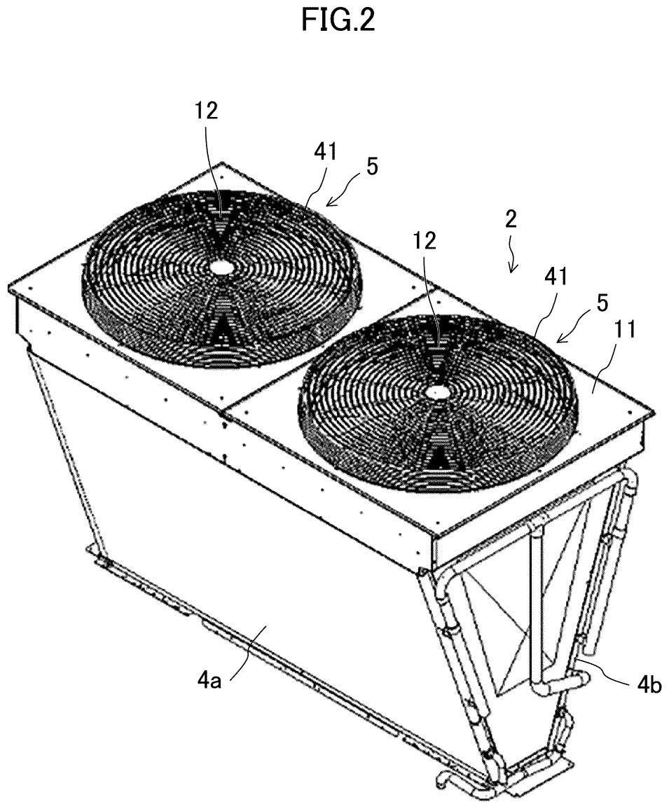

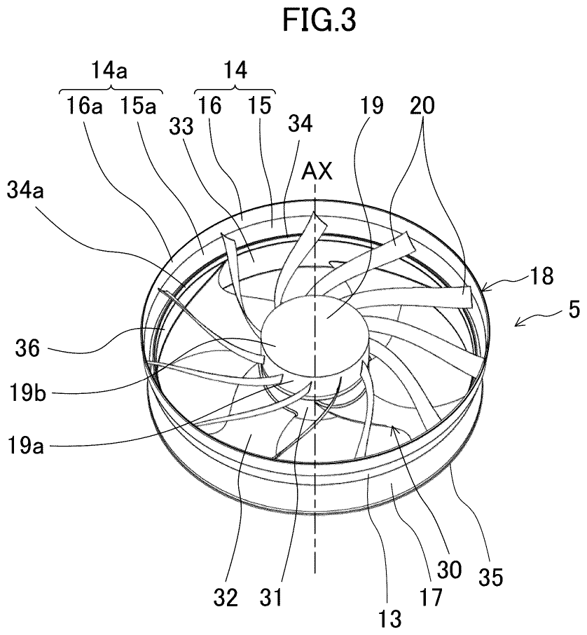

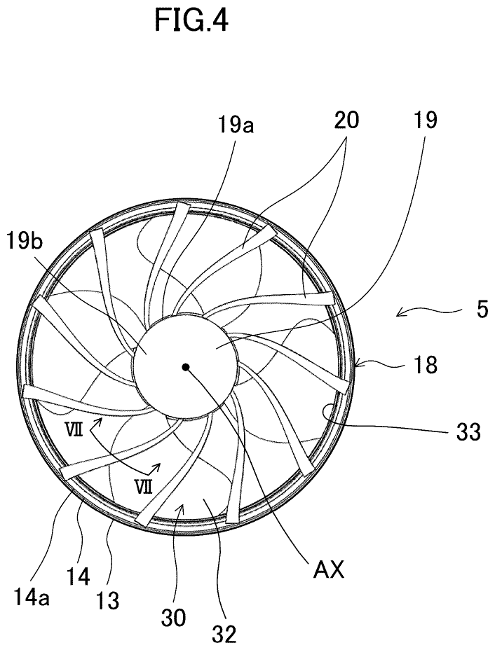

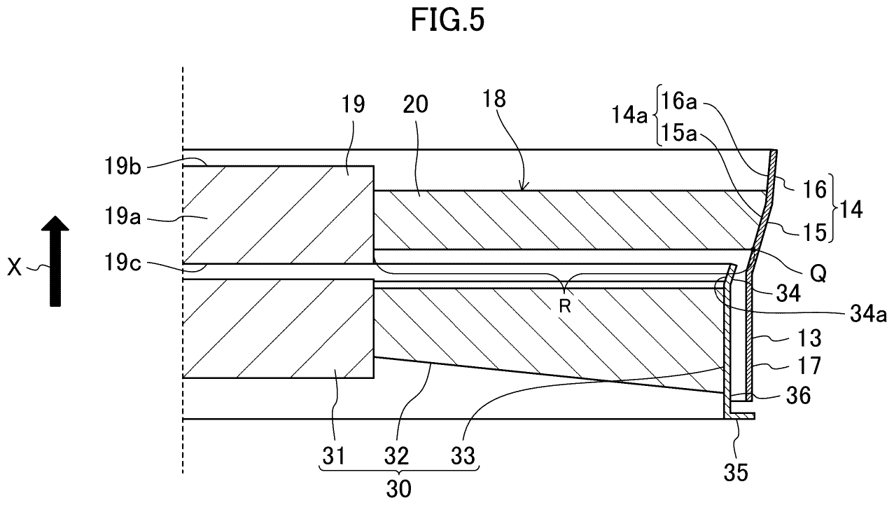

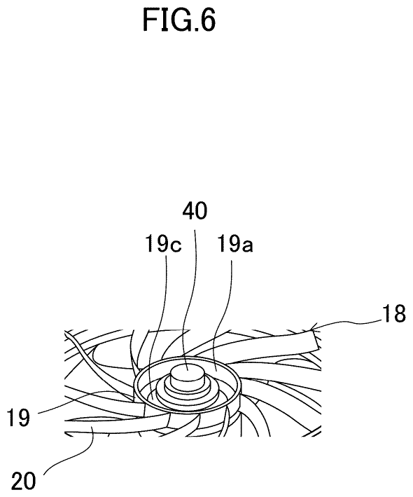

As illustrated in FIG. 2, the chiller unit (2) includes a pair of heat exchangers (4a, 4b) that are rectangular in plan view. The heat exchangers (4a, 4b) are arranged to have their longitudinal direction oriented horizontally and to face each other to form a substantially V-shaped cross section that opens upward. A rectangular upper panel (11) made of metal and having panel surfaces oriented in the top-bottom direction is arranged above the heat exchangers (4a, 4b) to cover the heat exchangers (4a, 4b) from above. The upper panel (11) has a pair of circular vents (12) spaced apart from each other in the longitudinal direction of the heat exchangers (4a, 4b). An air blowing device (5) of a first embodiment of the present disclosure illustrated also in FIGS. 3 to 6 is arranged inside each vent (12). The air blowing devices (5) each include a stator vane (18) fixed to the upper panel (11): a rotor vane (30) provided below the stator vane (18) rotatably around its axis (AX) extending in the top-bottom direction: and a motor (40) illustrated in FIG. 6 only and rotating the rotor vane (30) in the counterclockwise direction when viewed from above so as to transfer air upward from the bottom. The arrow X in FIG. 5 indicates the direction in which air is transferred. Thus, the upper side of this figure is the downstream side, and the lower side thereof is the upstream side. The counterclockwise direction when viewed from above is the rotation direction of the rotor vane (30). The air blowing devices (5) are each covered from above by a blower grille (41) illustrated in FIG. 2 only.

The stator vane (18) includes a fixed hub (19): eleven fixed blades (20) circumferentially spaced apart from one another and protruding radially outward from the fixed hub (19); and a shroud (13) connected to outer peripheral ends of the fixed blades (20).

The fixed hub (19) integrally includes a tube portion (19a) having its axial direction oriented in the top-bottom direction: an upper surface portion (19b) having a circular shape and blocking an upper end of the tube portion (19a): and a lower surface portion (19c) (illustrated in FIG. 6 only) having a ring shape and protruding inward from a lower edge of the tube portion (19a) to face the upper surface portion (19b). A mounting hole (not shown) for mounting a motor is formed inside the lower surface portion (19c). As illustrated in FIG. 6, the motor (40) is mounted to the lower surface portion (19c). The tube portion (19a) houses the motor (40) except the shaft thereof, and the shaft of the motor (40) is inserted into the mounting hole of the lower surface portion (19c).

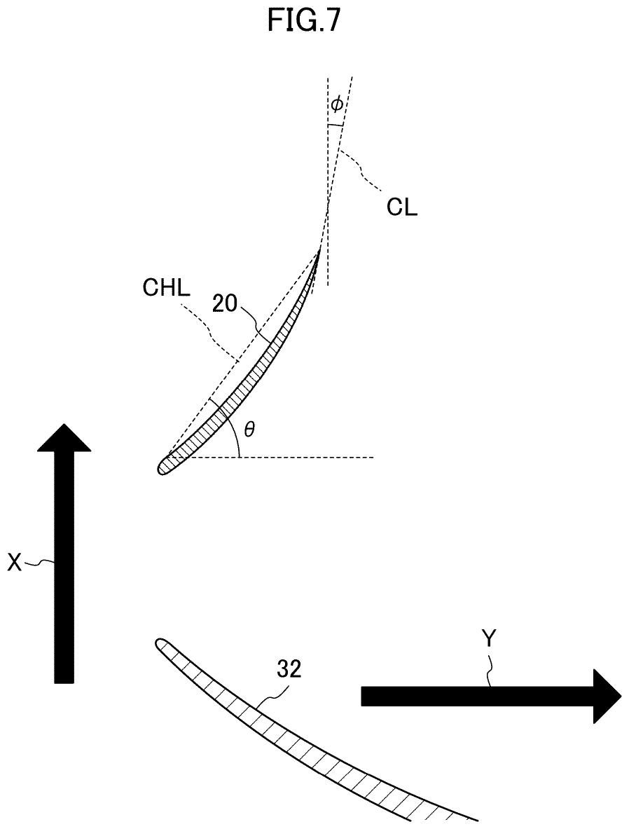

The fixed blades (20) each have a long plate shape, and are integrated with and protrude from an outer peripheral surface of the tube portion (19a) of the fixed hub (19). As illustrated in FIG. 7, the chord line (CHL) of each fixed blade (20) throughout the radial direction is inclined downstream in the rotation direction of the rotor vane (30). In FIG. 7, the arrow Y indicates the rotation direction of the rotor vane (30).

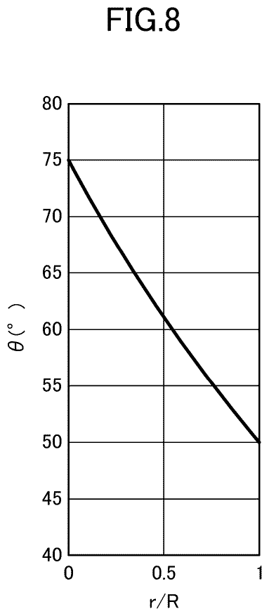

FIG. 8 shows the relation between the installation angle (θ) and the ratio of a radial distance from the fixed hub (19) to the radial length of the upstream edge of each fixed blade (20). In FIG. 8, the horizontal axis represents r/R, where R is the radial length of the upstream edge of the fixed blade (20) (the radial distance between the fixed hub (19) and the point of intersection (Q) of the upstream edge of the fixed blade (20) and the inner peripheral surface of the shroud (13)), and r is a radial distance from the fixed hub (19). Thus, the installation angle (θ) formed by the chord line (CHL) of each fixed blade (20) with respect to a plane perpendicular to the axis (AX) decreases gradually from the inner peripheral side toward the outer peripheral side of the fixed blade (20). Thus, the average of the installation angle (θ) on the outer peripheral side of the fixed blade (20) from the midpoint of the straight line extending in the radial direction from the outer periphery of the upstream edge of the fixed blade (20) to the outer peripheral surface of the fixed hub (19) is less than the average of the installation angle (θ) on the inner peripheral side of the fixed blade (20) from the midpoint of the straight line, where the installation angle (θ) is formed by the chord line (CHL) of the fixed blade (20) with respect to the plane perpendicular to the axis (AX).

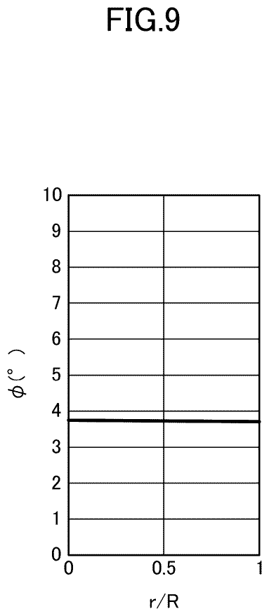

The installation angle (θ) at the inner peripheral end of the upstream edge of the fixed blade (20) is set greater by 14 or more degrees than the installation angle (θ) at the outer peripheral end of the upstream edge of the fixed blade (20). In a circumferential sectional view, the angle (q) formed by a centerline (CL) and the axis (AX) at a downstream end of the fixed blade (20), where the centerline (CL) extends through the center of the fixed blade (20) in the thickness direction, is constant throughout the radial direction as shown in FIG. 9. Here, if the centerline (CL) is a curved line, the angle (@) is the angle formed by a tangent line to the centerline (CL) and the axis (AX) at the downstream end of the fixed blade (20).

The shroud (13) has a substantially constant thickness throughout the circumferential direction and the direction of the axis (AX). The shroud (13) includes a downstream end (base end) having a shroud inclined portion (14) formed throughout the periphery of the downstream end and inclined downstream toward the outer peripheral side. The shroud inclined portion (14) includes a tapered upstream inclined portion (15) and a tapered downstream inclined portion (16). The downstream inclined portion (16) is less inclined with respect to the direction of the axis (AX) of the rotor vane (30) than the upstream inclined portion (15), and is formed downstream of the upstream inclined portion (15). The shroud inclined portion (14) includes an inner peripheral surface constituting a shroud inclined surface (14a) inclined downstream toward the outer peripheral side. The shroud inclined surface (14a) includes an upstream end having an upstream inclined surface (15a) serving as an inner peripheral surface of the upstream inclined portion (15). The shroud inclined surface (14a) includes a portion downstream of the upstream inclined surface (15a) which has a downstream inclined surface (16a) serving as an inner peripheral surface of the downstream inclined portion (16). The upstream inclined portion (15), the upstream inclined surface (15a), the downstream inclined portion (16), and the downstream inclined portion (16a) are straight in a radial sectional view.

A portion of the shroud (13) except the shroud inclined portion (14) (i.e., a portion of the shroud (13) upstream of the upstream inclined portion (15)) constitutes a circular cylindrical shroud tubular portion (17).

An upper end portion of the upstream inclined portion (15) and a lower end portion of the downstream inclined portion (16) of the shroud (13) are connected with the outer peripheral ends of the fixed blades (20).

The rotor vane (30) is provided upstream of (or below) the stator vane (18) rotatably around the axis (AX) extending in the top-bottom direction. As illustrated in FIG. 10, the rotor vane (30) includes a rotor hub (31), four rotary blades (32), and a ring (33).

The rotor hub (31) is columnar, and has a center axis portion coupled to the shaft of the motor (40).

The four rotary blades (32) are circumferentially spaced apart from one another and protrude radially outward from the rotor hub (31). As illustrated in FIG. 7, each rotary blade (32) is inclined upstream (downward) in the counterclockwise direction when viewed from above throughout the radial direction. In other words, each rotary blade (32) is inclined upstream in the rotation direction (i.e., the direction indicated by the arrow Y) throughout the radial direction. Thus, when the rotary blades (32) rotate in the counterclockwise direction, air is transferred from bottom to top.

The ring (33) is substantially tubular, and is connected to outer peripheral ends of the rotary blades (32) to surround the rotary blades (32) and the rotor hub (31) from the outer peripheral side. The ring (33) has a substantially constant thickness throughout the circumferential direction and the direction of the axis (AX). The ring (33) includes a downstream end having a ring inclined portion (34) formed throughout the periphery of the downstream end and inclined downstream toward the outer peripheral side. The ring inclined portion (34) includes an outer peripheral surface constituting a ring inclined surface (34a) inclined downstream toward the outer peripheral side. In other words, the outer peripheral surface of the downstream end of the ring (33) has the ring inclined surface (34a) formed throughout the periphery of the outer peripheral surface and inclined downstream toward the outer peripheral side.

The ring (33) includes an upstream end having a protrusion (35) formed throughout the upstream end and protruding toward the outer peripheral side.

A portion of the ring (33) except the ring inclined portion (34) and the protrusion (35) (i.e., a portion of the ring (33) upstream of the ring inclined portion (34) and downstream of the protrusion (35)) constitutes a circular cylindrical ring tubular portion (36). The ring tubular portion (36) is connected with the outer peripheral ends of the rotary blades (32).

The rotor hub (31) and the rotary blades (32) of the rotor vane (30) configured as described above are arranged in whole inside the shroud (13). A portion of the rotor vane (30) except a lower end portion of the ring (33) is arranged inside the shroud (13). A lower end portion of the ring tubular portion (36) and the protrusion (35) of the ring (33) are located below the lower end of the shroud (13).

In the chiller unit (2) configured as described above, when the rotor vane (30) is rotated by driving of the motor (40), air having passed through the heat exchangers (4a, 4b) is blown out upward as a swirling airflow swirling in the rotation direction of the rotor vane (30).

At this time, since the average of the installation angle (θ) on the inner peripheral side of the fixed blade (20) from the midpoint of the straight line extending in the radial direction from the outer peripheral end of the upstream edge of each fixed blade (20) to the outer peripheral surface of the fixed hub (19) is set greater than the average of the installation angle (θ) on the outer peripheral side of the fixed blade (20) from the midpoint of the straight line, swirling of air is effectively reduced on the inner peripheral side of the fixed blade (20) from the midpoint of the straight line.

Further, since the installation angle (θ) is the greatest at the inner peripheral end of the upstream edge of each fixed blade (20), swirling of air is effectively reduced around the inner peripheral end of the fixed blade (20).

Further, since, in a circumferential sectional view, the angle (p) formed by the centerline (CL) and the axis (AX) at the downstream end of the fixed blade (20), where the centerline (CL) extends through the center of the fixed blade (20) in the thickness direction, is constant throughout the radial direction, the direction of the air blown out from the stator vane (18) is easily made uniform throughout the circumferential direction of the stator vane (18).

Further, since the shroud (13) reduces air flowing toward the outer peripheral side of the stator vane (18), generation of a short circuit is reduced.

Further, since the inner peripheral surface of the downstream end of the shroud (13) constitutes the shroud inclined surface (14a) inclined downstream toward the outer peripheral side, the flow path of air passing through the inside of the shroud (13) widens downstream toward the outer peripheral side, thereby reducing the velocity of air flowing through the outer peripheral end of the stator vane (18). This leads to less reduction in the efficiency and less increase in the noise due to the interference between the fixed blades (20) and air at the outer peripheral end of the stator vane (18).

Further, since the number of the fixed blades (20) and the number of the rotary blades (32) are mutually prime, there is less interference between the tip vortices of the fixed blades (20) and the tip vortices of the rotary blades (32), thereby reducing unusual sounds.

Further, since the ring (33) is connected to the outer peripheral ends of the rotary blades (32), generation of tip vortices of the rotary blades (32) is reduced, thereby reducing unusual sounds.

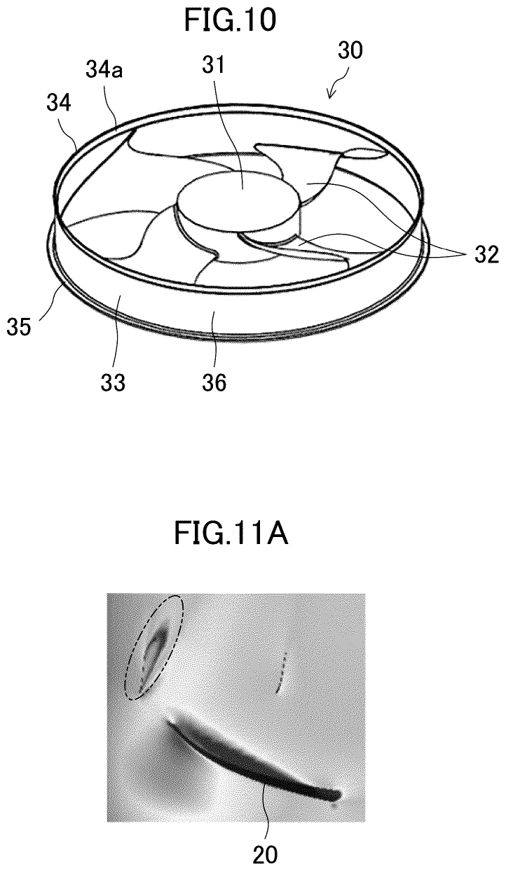

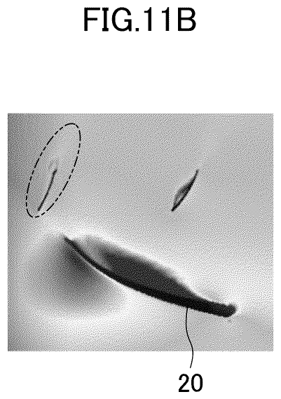

FIG. 11A shows a velocity distribution of air around the fixed blade (20). FIG. 11B corresponds to FIG. 11A, where the installation angle (θ) of the fixed blade (20) at the outer peripheral portion thereof is set smaller than in FIG. 11A.

In FIGS. 11A and 11B, as the air velocity becomes lower, the color turns darker. In FIG. 11B, a low-velocity region in an area surrounded by the dot-dot-dash line is smaller than that in FIG. 11A. In other words, FIGS. 11A and 11B teach that as the installation angle (θ) at the outer peripheral portion of the fixed blade (20) is made smaller, the low-velocity region appearing slightly apart from the downstream end of the fixed blade (20) can be smaller. It can be deduced that as the installation angle (θ) at the outer peripheral portion of the fixed blade (20) is made smaller, there is less flow separation at a location slightly apart from the downstream end of the fixed blade (20).

FIG. 12 shows an air blowing device (5) of a comparative example. In the air blowing device (5) of the comparative example, the installation angle (θ) of each fixed blade (20) is different from that of the first embodiment, while the other configurations of the comparative example are the same as, or similar to those of the first embodiment.

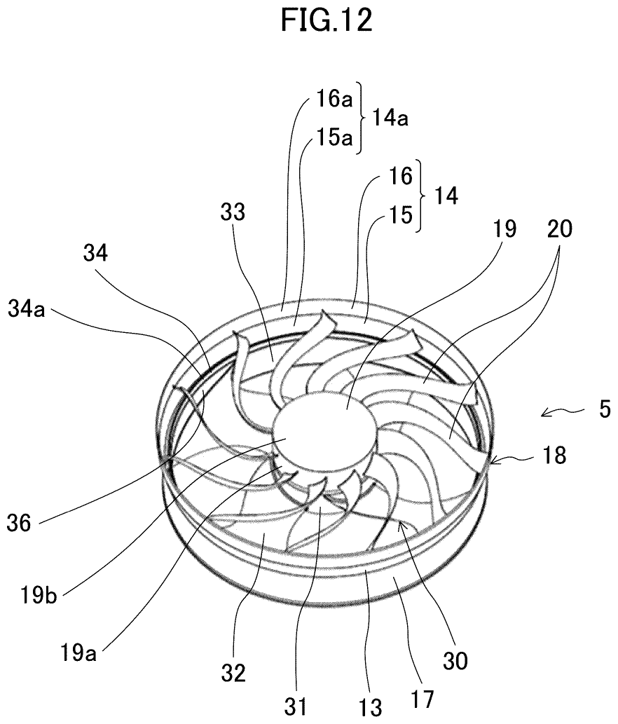

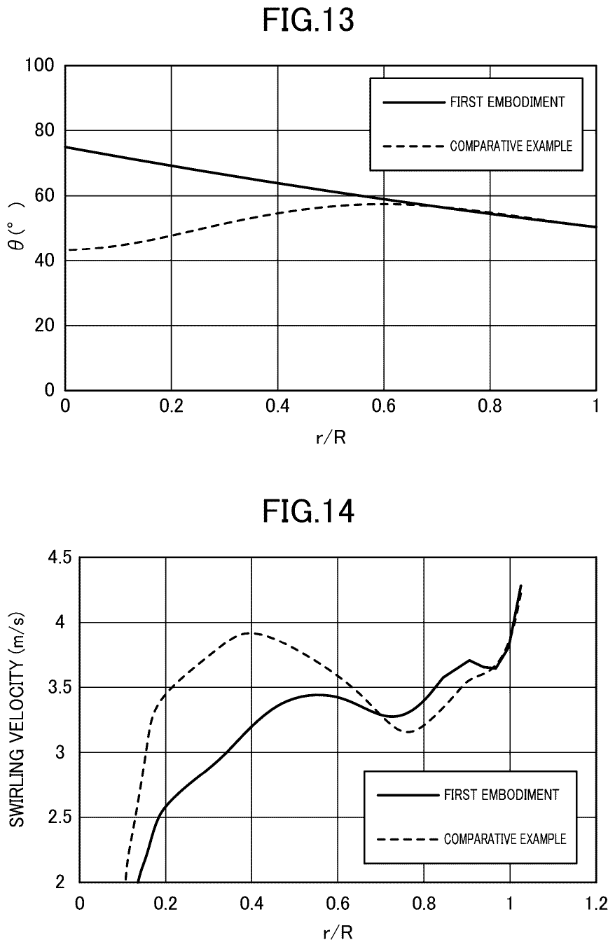

FIG. 13 shows the installation angle (θ) of the fixed blade (20) of the first embodiment and the comparative example.

In the comparative example, the average of the installation angle (θ) on the outer peripheral side of the fixed blade (20) from the midpoint of the straight line extending in the radial direction from the outer periphery of the upstream edge of the fixed blade (20) to the outer peripheral surface of the fixed hub (19) is greater than the average of the installation angle (θ) on the inner peripheral side of the fixed blade (20) from the midpoint of the straight line.

FIG. 14 shows the swirling velocities (the circumferential air velocities) at radial positions calculated based on the measurement results measured on a measurement surface located on the downstream side of the stator vane (18) of the first embodiment and the comparative example.

As shown in FIG. 14, the swirling velocity near the fixed hub (19) of the first embodiment is lower than that of the comparative example. The average swirling velocity throughout the radial direction of the first embodiment, which is 3.02 m/s, is lower than the average swirling velocity throughout the radial direction of the comparative example, which is 3.18 m/s.

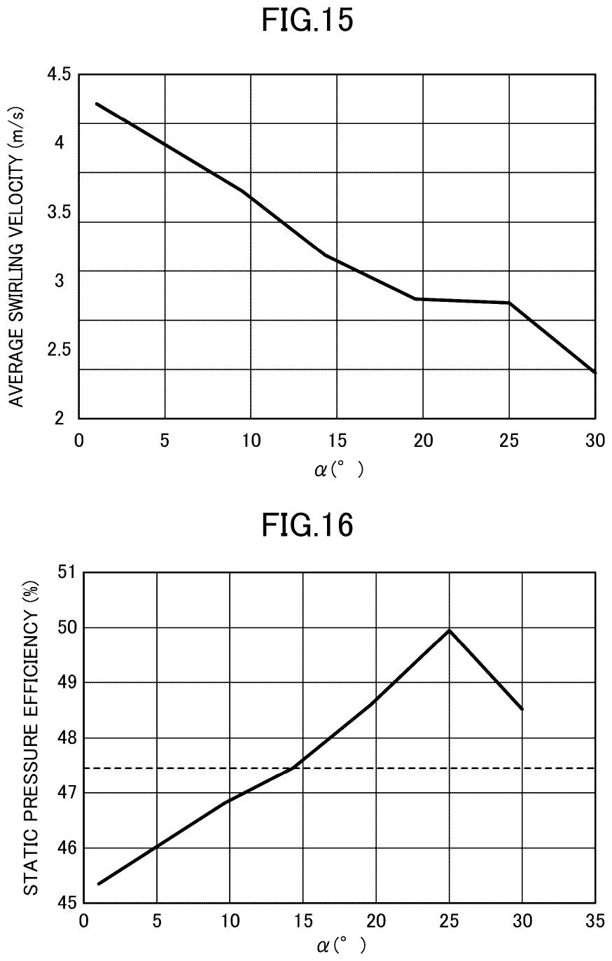

FIG. 15 shows the relation between the average swirling velocity throughout the radial direction and the difference (a) obtained by subtracting the installation angle (θ) at the outer peripheral end of the upstream edge of the fixed blade (20) from the installation angle (θ) at the inner peripheral end of the upstream edge of the fixed blade (20).

As shown in FIG. 15, as the difference (a) becomes larger, the average swirling velocity becomes lower.

FIG. 16 shows the relation between the difference (a) and the static pressure efficiency of the air blowing device (5).

As shown in FIG. 16, as the difference (a) becomes larger, the static pressure efficiency of the air blowing device (5) becomes higher. In this figure, the static pressure efficiency of the comparative example is indicated by the dashed line. When the difference (a) is set to 14 or more degrees, the static pressure efficiency can be higher than that of the comparative example.

Thus, when the difference (a) is set to 14 or more degrees, i.e., the installation angle (θ) at the inner peripheral end of the upstream edge of the fixed blade (20) is set greater by 14 or more degrees than the installation angle (θ) at the outer peripheral end of the upstream edge of the fixed blade (20), swirling can be more effectively reduced on the inner peripheral side of the stator vane (18), the amount of air swirling at the whole of the outlet of the air blowing device (5) can be reduced, and the static pressure efficiency can be improved. Further, when swirling is reduced, noise can be reduced.

According to this first embodiment, the motor (40) is attached to the fixed hub (19) of the stator vane (18), and thus it is unnecessary to provide an attachment member for the motor (40) separately from the stator vane (18). Thus, space saving can be achieved.

### Second Embodiment

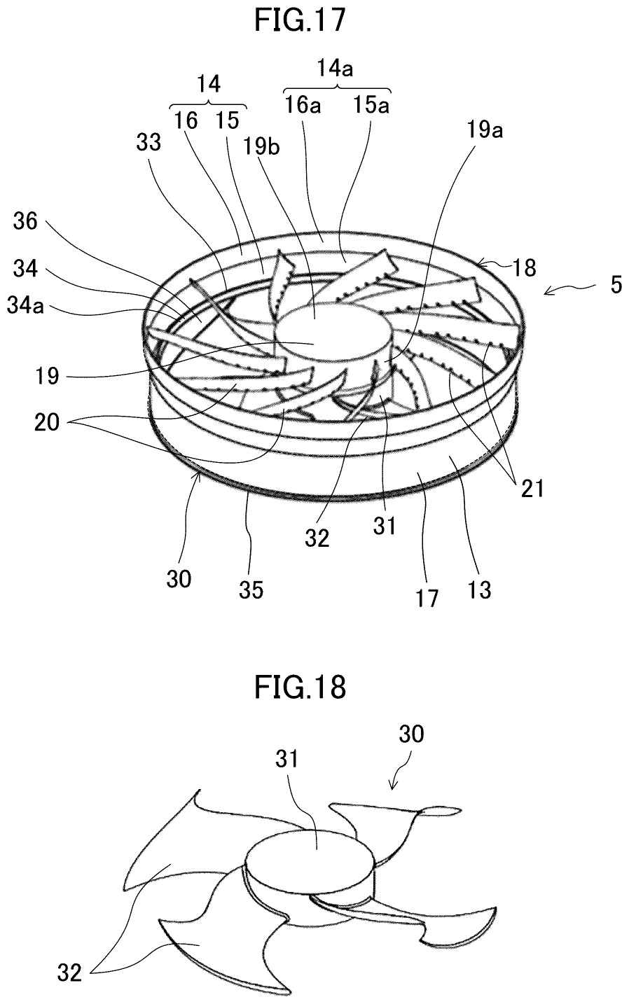

FIG. 17 shows an air blowing device (5) of a second embodiment of the present disclosure. In the second embodiment, the upstream edge of each fixed blade (20) has serrations (21) throughout the length direction. In other words, the upstream edge of each fixed blade (20) has serrated grooves equally spaced apart from one another throughout the length direction.

The other configurations and operations of this embodiment are the same as, or similar to, those of the first embodiment. Thus, the same reference characters are used to indicate the same components, which will not be described in detail.

According to the second embodiment, the upstream edge of each fixed blade (20) has serrations (21) throughout the length direction, and thus there can be less flow separation around the upstream end of the fixed blade (20).

### OTHER EMBODIMENTS

In the first and second embodiments, the present invention is applied to a case where the rotor vane (30) includes the ring (33), but as illustrated in FIG. 18, the present invention is also applicable to a case where the rotor vane (30) does not include the ring (33).

In the first and second embodiments, the shroud inclined surface (14a) and the ring inclined surface (34a) are straight in a radial sectional view, but may be curved to protrude toward the inner peripheral side.

In the first and second embodiments, the present invention is applied to the air blowing device (5) configured to blow air upward, but the present invention is also applicable to an air blowing device configured to blow air downward, and an air blowing device including a rotor vane (30) having an axis (AX) oriented in the horizontal direction (i.e., an air blowing device configured to blow air in the horizontal direction).

In the first and second embodiments, the stator vane (18) includes the eleven fixed blades (20), but may include not eleven but the other plurality of fixed blades (20).

In the first and second embodiments, the rotor vane (30) includes the four rotary blades (32), but may include not four but the other plurality of rotary blades (32).

### INDUSTRIAL APPLICABILITY

As described above, the present disclosure is useful for an air blowing device and an air conditioning system including the air blowing device.

### DESCRIPTION OF REFERENCE CHARACTERS

1 Air Conditioning System
5 Air Blowing Device
13 Shroud
14a Shroud Inclined Surface
18 Stator Vane
19 Fixed Hub
20 Fixed Blade
21 Serration
30 Rotor Vane
32 Rotary Blade
33 Ring
40 Motor
CHL Chord Line
AX Axis
θ Installation Angle
CL Centerline

1. An air blowing device comprising:
a stator vane including a fixed hub and a plurality of fixed blades that protrude radially outward from the fixed hub and are circumferentially spaced apart from one another; and
a rotor vane including a plurality of rotary blades and disposed upstream of the stator vane,
the fixed blade having a chord line inclined downstream in a rotation direction of the rotor vane throughout a radial direction,
an average of an installation angle on an outer peripheral side of the fixed blade from a midpoint of a straight line extending in the radial direction from an outer peripheral end of an upstream edge of the fixed blade to an outer peripheral surface of the fixed hub being less than an average of the installation angle on an inner peripheral side of the fixed blade from the midpoint of the straight line, where the installation angle is formed by the chord line of the fixed blade with respect to a plane perpendicular to an axis,
the rotary blade having a chord line inclined upstream in the rotation direction throughout the radial direction.

2. The air blowing device of claim 1, wherein
the installation angle decreases gradually from the inner peripheral side toward the outer peripheral side of the fixed blade.

3. The air blowing device of claim 1, wherein
the installation angle at an inner peripheral end of the upstream edge of the fixed blade is greater by 14 or more degrees than the installation angle at the outer peripheral end of the upstream edge of the fixed blade.

4. The air blowing device of claim 1, wherein
in a circumferential sectional view, an angle formed by a centerline and the axis at a downstream end of the fixed blade, where the centerline extends through a center of the fixed blade in a thickness direction, is constant throughout the radial direction.

5. The air blowing device of claim 1, wherein
the fixed blade includes an outer peripheral end connected to an annular shroud.

6. The air blowing device of claim 5, wherein
the shroud includes a downstream end having an inner peripheral surface constituting an inclined surface inclined downstream toward the outer peripheral side.

7. The air blowing device of claim 1, wherein
the number of the fixed blades and the number of the rotary blades are mutually prime.

8. The air blowing device of claim 1, wherein
the rotary blade includes an outer peripheral end connected to a ring.

9. The air blowing device of claim 1 further comprising:
a motor configured to rotate the rotor vane,
the motor being attached to the fixed hub.

10. The air blowing device of claim 1, wherein
the upstream edge of the fixed blade has serrations.

11. An air conditioning system comprising:
the air blowing device of claim 1.

12. The air blowing device of claim 2, wherein
the installation angle at an inner peripheral end of the upstream edge of the fixed blade is greater by 14 or more degrees than the installation angle at the outer peripheral end of the upstream edge of the fixed blade.

13. The air blowing device of claim 2, wherein
in a circumferential sectional view, an angle formed by a centerline and the axis at a downstream end of the fixed blade, where the centerline extends through a center of the fixed blade in a thickness direction, is constant throughout the radial direction.

14. The air blowing device of claim 3, wherein
in a circumferential sectional view, an angle formed by a centerline and the axis at a downstream end of the fixed blade, where the centerline extends through a center of the fixed blade in a thickness direction, is constant throughout the radial direction.

15. The air blowing device of claim 2, wherein
the fixed blade includes an outer peripheral end connected to an annular shroud.

16. The air blowing device of claim 3, wherein
the fixed blade includes an outer peripheral end connected to an annular shroud.

17. The air blowing device of claim 4, wherein
the fixed blade includes an outer peripheral end connected to an annular shroud.

18. The air blowing device of claim 2, wherein
the number of the fixed blades and the number of the rotary blades are mutually prime.

19. The air blowing device of claim 3, wherein
the number of the fixed blades and the number of the rotary blades are mutually prime.

20. The air blowing device of claim 4, wherein
the number of the fixed blades and the number of the rotary blades are mutually prime.
